(19) United States
(12) Patent Application Publication
(10) Pub. No.: US 2011/0066821 A1
(43) Pub. Date: Mar. 17, 2011

(54) DATA HANDLING SYSTEM COMPRISING A REARRANGEMENT NETWORK

(75) Inventors: Erik Rijshouwer, Eindhoven (NL); Cornelis Hermanus Berkel Van Berkel, Heeze (NL)

(73) Assignee: NXP B.V., Eindhoven (NL)

(21) Appl. No.: 12/993,847

(22) PCT Filed: May 19, 2009
(86) PCT No.: PCT/IB09/52078

§ 371 Date: Nov. 22, 2010

(30) Foreign Application Priority Data
May 21, 2008 (EP) 08104056.0

(51) Int. Cl. G06F 12/00

(52) U.S. Cl. 711/165; 711/E12.001

(57) ABSTRACT

A data handling system wherein the system is configured for receiving at an input a first plurality of commands, the plurality of commands comprising a plurality of read commands, and for producing at an output a second plurality of data objects; the system comprises: a plurality of memory banks, a distributor (102), a plurality of access modules (104), and a rearranging network (108). Wherein the commands are buffered to avoid bank conflicts, and wherein the retrieved data objects are rearranged by the rearrangement network.

### FIELD OF THE INVENTION

The invention relates to a data handling system.

In particular, the invention relates to a data handling system wherein the system is configured for receiving at an input a first plurality of commands, the plurality of commands comprising a plurality of read commands, and for producing at an output a second plurality of data objects; the system comprises: a plurality of memory banks.

The invention also relates to a method for rearranging data.

The invention also relates to a rate matcher.

### BACKGROUND OF THE INVENTION

In virtually every modem transmission or reception device, such as those for, e.g., GSM and UMTS R99, a data interleaving step, i.e. a data reordering step, is used.

Data interleaving is the process of reordering the data according to some predetermined pattern. Typically, the interleaving uses a block interleaving pattern, wherein the data is organized in a rectangular matrix. First the whole interleaving block is written to the memory according to a well-chosen access sequence, and then the block is read out by means of the second access sequence. For example, the matrix is written in the order of the rows but read in the order of the columns. These sequences combined implement the required interleaving operation.

Note that by using an interleaving scheme's access sequences, while swapping the reading and writing commands, its associated deinterleaving scheme is obtained. For example, the matrix is written in the order of the columns but read in the order of the rows. A data interleaver and corresponding deinterleaver are typically implemented as write and read sequences to a Random access memory (RAM).

Interleaving has an inherent high latency associated with its operation because of its data dependencies.

Interleaving has numerous applications in the area of computer science, error correcting codes and communications. For example, if data is interleaved prior to encoding with an error correcting code the data becomes less vulnerable to burst errors. The latter is especially important for communications, including mobile communications, but is also used for data storage. Data interleaving can also be used for multiplexing multiple sources of digital streams, for example, to combine a digital audio stream and a digital video stream into one multimedia stream.

If the required data-rates are low, often programmable solutions on a DSP or micro-controller are used. For higher data-rates and/or throughput requirements a random access memory with dedicated address generation hardware is used, for example, for WLAN.

The throughput requirements on a memory used for interleaving are constantly rising. The most important reason for this is the increasing data rates required by the communication standards. To give an indication of this increase, the throughput requirements for 3 G communication standards are given below in Table 1, along with a next generation in Table 2.

Note: Msbit/s stands for Mega soft-bits per second, which is a measurement of data rate. One soft-bit corresponds with 4 or 5 real bits, depending on the precision used by the demodulator.

TABLE 1
3G Standards

| Standard | Throughput |
|---|---|
| 802.11a/g | 72 Msbit/s |
| DAB | 4.6 Msbit/s |
| DVB | 81 Msbit/s |
| UMTS | 8.8 Msbit/s |
| HSDPA | 42 Msbit/s |

TABLE 2
4G Standards

| Standard | Throughput |
|---|---|
| UMTS LTE | 300 Msbit/s |
| 802.11n | 600 Msbit/s |

Furthermore, upstream and downstream often have to be supported simultaneously, leading to a higher architecture load. Also, multi-standard solutions not only have to process the sum of the individual data rates, but can be stressed even further because of tight latency constraints. The result of these developments is that the sum of access rates on the memory has become much larger than the maximally attainable memory frequency.

When using a multi-bank memory, a new problem arises: if two or more elements of an access vector are assigned to the same bank a so-called conflict occurs since a bank can only process one element at the same time. For example, such a conflict occurs if an access vector, i.e. command vector, contains two write commands destined for a memory bank, or if an access vector contains two read commands destined for the memory bank. The distributor can resolve this conflict by splitting the access vector up into two new access vectors such that each new access vector comprises only one of the two addresses that gave the conflict. As a result, two cycles are used to process the original access vector. This corresponds with a memory efficiency of 50%.

Depending on the characteristics of the interleaving scheme, it is seldom possible to process many consecutive access vectors without having bank conflicts.

The worst-case scenario for bank conflicts occurs for certain block interleaving access patterns. If the number of banks, P, is a divider of the number of columns, C, of the matrix, i.e. the block interleaving function, a total of C bursts of bank conflicts occur. In this case the memory efficiency drops to only 1/P*100%. In particular, this situation occurs in the situation where the number of columns is equal to the number of banks used.

It is a problem of the prior art that existing memory architectures are inefficient when used for data interleaving.

### SUMMARY OF THE INVENTION

It is an object of the invention to provide a memory architecture that can handle data interleaving efficiently.

The object is achieved by the data handling system according to the invention, as defined in claim 1.

The inventors have realized that a memory access sequence cannot be mapped directly to a multi-bank memory. Instead a more sophisticated approach is required to enable higher levels of efficiency.

A command can comprise, or consist of, an index representing a memory location. An index could be a memory address, but the index could also be an index as used in a block interleaving pattern. The range of indices need not encompass the whole memory. A translation function may be necessary to convert an index to a physical address. The translation function may comprise adding an offset to the index. The translation function may, as an intermediate step, translate the index to a virtual address. The translation function may be comprised in the distributor and/or a memory bank. The translation function may also be comprised in a translator unit, such as a memory management unit, employed by the data handling system.

If a bank conflict occurs in the plurality of commands the distributor does not need to resolve this conflict, but can continue regular operation, since each bank has a corresponding access module to buffer the conflicting commands. These access modules enable the decoupling of commands for the different banks by rescheduling.

As a result all memory banks can store or retrieve a data object at each cycle, whereas without the plurality of access modules some of the memory banks would be idle when a conflict occurs.

Furthermore, since the data handling system comprises a rearrangement network, the system can control the arrangement in which the data objects are outputted. This makes the data handling system a flexible, multi-purpose tool. For example, the rearrangement network can organize the plurality of data objects in the same way the plurality of read commands were organized, but this is not necessary.

The rearrangement network can organize the data in any desirable arrangement. For example, the rearrangement network could convert data stored in a little-endian representation to big-endian representation, by reverting the order of each set of a predetermined number of bits. In the situation of the latter example, data stored in a little-endian representation would present itself to software using the data handling system as data stored in a big-endian representation. From the perspective of a software application using the system, this translation would be transparent.

The first plurality of commands can be organized temporally in many ways, e.g., the commands may arrive at the input sequentially or in parallel. There is no need for the commands to arrive according to a fixed schedule but can arrive as soon as a processing device upstream makes them available, in this way the data handling system can be used in a asynchronous design.

Each access module may buffer the same amount of data, but it is also possible for some access modules to be capable of buffering more data than others.

The invention may be used to advantage in any device or for any application requiring high data rates, as long as the memory access behavior is roughly balanced over the banks.

A preferred embodiment of the data handling system according to the invention is characterized by the measure of claim 2.

By using the rearrangement network to ensure that the data object vectors outputted by the system are in the same order wherein the read command vectors were received makes the data handling system transparent from the perspective of software using the system. Apart from the latency, the software cannot tell that the data handling system has a multi-bank memory architecture. Compared to a system without a rearrangement network this is an advantage. Without this advantage software needs to take into account exactly in what order the data objects will be outputted. Moreover, it may, in theory, be possible for a programmer to work out in advance where conflicts will occur and how to compensate for them in the software. But using the data handling system according to the invention as defined in claim 2 the programmer's task is greatly simplified, also the throughput and efficiency of software using the system increases.

The first sequence of command vectors could at some point have been organized sequentially. For example, a plurality of commands can be offered to the input sequentially, whereupon the distributor organizes the commands into a sequence of vectors, for example, by processing a fixed number of commands at a time. In this way, the data handling system can be comprised in a non-vector architecture as well as in a vector architecture. On the other hand, the distributor could also handle a linear sequence, in order as received, distributing the commands one-by-one.

An ordered set according to a ranking is a set with a first, second, etc, and last element. Note, in case of a set with two elements, the second and last element refer to the same element.

A practical embodiment of the data handling system according to the invention is characterized by the measure of claim 3.

The rearranging network preferably comprises a rearrangement buffer to store the data objects that are supplied to the rearranging network by the plurality of memory banks. In a preferred embodiment the rearrangement buffer comprises a plurality of rearrangement bank buffers, such that each memory bank supplies to a respective rearrangement bank buffer.

The rearrangement buffer gives the advantage that the rearranging network can be organized in a rearrangement buffer and an element selection network.

A preferred embodiment of the data handling system according to the invention is characterized by the measure of claim 4.

The tag can signal some information regarding the plurality of read commands and/or the order in which they were received to the rearrangement network. A tag could comprise a time stamp. In case the read command is comprised in a read command vector, the tag could comprise a representation of the rank of the read command in the read command vector. Also, a representation of the address and/or a representation of the way the addresses are comprised in the plurality of read commands. Any combination of the above and other information can be combined to advantage.

Each tag assigned by the distributor may be different, but this is not necessary.

Based on the tags supplied together with the data objects the rearrangement network can construct the desired ordering of the data objects, such as the same ordering in which the read commands were received.

By assigning a tag to each read command, the distributor can transfer information, regarding the arrangement in which the read commands were received by the distributor, to the rearrangement network through the same hardware as the read commands themselves are processed. This solves the problem of getting information from the distributor to the rearrangement network. Preferably the tags, convey the order in which the read commands were received by the distributor.

A preferred embodiment of the data handling system according to the invention is characterized by the measure of claim 5.

A preferred way of assigning tags by the distributor is to assign tags according to a tag sequence. In case the arrangement in which the read commands were received was a linear sequential arrangement each tag could be assigned a number representing the order in which the read commands were received. If some read commands are received in parallel the distributor must break the tie, for example, according to a ranking. In particular, when a sequence of read command vectors is received the distributor can assign tags according to the rank in the vector. For example, the read command with the lowest ranking could be assigned the first tag; the read command with the next lowest ranking could be assigned the next tag. After assigning a tag to the read command with the highest ranking in a read command vector, the distributor could assign the next tag to the read command with the lowest ranking in the next read command vector. In this way, the distributor can proceed.

The tag sequence could be the sequence of the natural integers in a suitable representation. There is no need for the tag sequence to be infinite; after the last tag in the tag sequence is used the tag sequence can be reused starting from the first tag. For example, the tag sequence could be the integers from 0 up to, but not including, a power of 2. The tag sequence can alternatively be a Gray code. Using a Gray code has the advantage that processing means for controlling the tag sequence is less complicated.

Using a tag sequence has the advantage that the rearrangement network can be configured to select data objects based on the same tag sequence. This saves on control and communication shared between the distributor and the rearrangement network.

It is a problem, that when the tag sequence contains two few different tags, there may be two commands contained in the access buffer tagged with same tag. If said two commands end up at the rearrangement network, then they may be selectable by the rearrangement network at the same time. In that situation the rearrangement network would need to break a tie. In a preferred embodiment, to solve this problem, the number of different tags in the tag sequence is larger or equal to the number of commands the access modules can store. For example, if the number of access modules is ‘ P’ and if each access module has a capacity for storing ‘D’ commands, then the tag sequence should comprise at least D×P, i.e. D multiplied with P, different elements.

A practical embodiment of the data handling system according to the invention is characterized by the measure of claim 6.

The first sequence may also comprise one or more write commands. The write commands may be organized as a sequence of write command vectors. Each write command vector comprises a set of write commands. A write command vector may have a ranking, although this is not necessary. The distributor can distribute the set of write commands among the distributor outputs.

The hardware used for the handling of read commands can be partially re-used to handle a write command. This includes distributing the write command using the distributor and buffering the write command with an access module before storing using a memory bank. In this way, no additional hardware is needed for storing information in the memory banks, apart from making the memory banks suitable for storing in addition to retrieving.

For a particular bank all read or write accesses are still executed in the relative order in which they were received by the distributor. As a result no Read after Write (RAW), Write after Read (WAR) or Write after Write (WAW) hazards can occur in this architecture.

A hazard preventing control means, such as a means for stalling the data handling system before a hazard occurs, is not needed for the architecture according to the invention. This brings the advantage of a higher throughput of the data handling system and less complicated hardware.

A preferred embodiment of the data handling system according to the invention is characterized by the measure of claim 7.

As a result of processing a plurality of read commands a buffer comprised in an access module may get full. If an access module is full, the data handling system cannot accept new read commands that could be distributed to the distributor output that is connected to the access module that is full. If such a situation is unaccounted for the data handling system may fail or at least the throughput will suffer. A full access buffer may occur if a plurality of commands is received with many bank conflicts, that is, many commands for the same bank.

It is a problem that some interleaving patterns, including some interleaving patterns that are needed for common communication standards, give rise to many bank conflicts. The situation described above will happen often for such interleaving patterns.

This problem is solved by using a permutator. The permutator applies a permutation to the distribution, such that an interleaving pattern that causes many commands to be distributed to a single memory bank, is transformed into a pattern in which those address are distributed among multiple banks.

If the distributor receives a plurality of commands that without a permutator would give rise to many bank conflicts, i.e. many commands would be sent to the same memory bank, the permutator breaks this pattern by assigning or redistributing some of the commands to a different memory bank and corresponding access module.

For example, if, without a permutator, a first command and a second command would be sent to a first memory bank, then the permutator can resolve this conflict by assigning the first command to the first memory bank but the second command to a second memory bank.

Note that the permutator can operate on read commands and write commands. It is convenient that a read command issued to retrieve an element stored in response to a previous write command is routed through the same permutator operating in the same configuration. In that way a read or write command comprising the same index will read from or write to the same physical location.

The permutator could be comprised in a clearly defined module, but on the other hand, the functionality of the permutator could be combined with the functionality of other modules, especially with a module for processing addresses or indices. For example, the permutator may be combined with the distributing of the distributor. The permutator could also be implemented outside the distributor, for example, in a separate module connected to the distributor outputs and the inputs of the plurality of access modules.

A permutator has the advantage that access modules will be full less frequently. As result, using the permutator the capacity of the access module may be reduced, leading to a cheaper design.

The invention using a permutator may be used to advantage in any device or for any application requiting high data rates, even if the memory access behavior is not balanced over the banks.

A preferred embodiment of the data handling system according to the invention is characterized by the measure of claim 8.

A particularly convenient way to permute the commands is by first processing the index with an address function. The address that results from processing an index with an address function can represent the physical location in a memory bank where the command is to store or retrieve. The address may also be a representation for an offset in the memory bank, or displacement with respected to a predetermined element in the memory bank. The address may also represent a virtual rather than a physical location. The use of virtual addresses is well known to a person skilled in the art.

By comprising, in the processing of the specific index to designate a specific distributor output, the adding of the specific address to the specific index, a cyclic permutation shift is accomplished. After the processing step of adding the specific address to the specific index additional processing may be done. For example, a modulo operation, i.e. a remainder after division operation, in particular, computing modulo the number of memory banks, can be done.

Bank conflict arises when a sequence of read or write commands, in combination with the number of memory banks is particularly unfortunate. With said combination is may happen that many bank conflicts arise. For example, for the block interleaving pattern, this happens if the number of banks, ‘P ’, is a divider of the number of columns, ‘C’.

By adding the address to the index, commands that would be distributed to the same bank, would need access to different banks. In this way, the cyclic permutation shift, resolves many of the bank conflicts.

If the permutator reduces the number of bank conflicts more than the permutator introduces new bank conflicts for some particular interleaving pattern, the permutator is advantageously applied. This can be tested by simulating an interleaving pattern, first without the permutator, and second with the permutator. Both in the first and in the second simulation the number of bank conflicts is counted. If the simulation with permutator gives fewer bank conflicts, the permutator is advantageously applied.

A preferred embodiment of the data handling system according to the invention is characterized by the measure of claim 9.

Making the distributor reconfigurable has the advantage that multiple interleaving schemes can be supported. It may happen that one configuration of the distributor is particularly effective for breaking up the patterns causing bank conflicts for one type of interleaving, yet is not effective, or worse, counter productive for another interleaving scheme.

One of way of reconfiguring the distributor is by reconfiguring a permutator. For example, it is conceivable that a permutator in a particular configuration can remove all conflicts for one interleaving scheme, yet introduce conflicts in another interleaving scheme. This problem is solved by reconfiguring the permutator in anticipation of the interleaving scheme that is about to be used. One way of reconfiguring is by having multiple permutators and choosing one among them.

The reconfiguration data can comprise among others, one or more of: a representation of a bank function, a representation of an address functions, and one or more parameters for use in such functions. Also, the reconfiguration data can comprise the particular application or operation to be performed, the distributor, or a permutator could select a way of distributing, i.e. adapting his selectivity, from a table stored in a memory comprised in the distributor. For example, the reconfiguration data can comprise a type of interleaving scheme.

One way of reconfiguring is to turn a permutator on or off. It is found that already a great advantage is achieved if the distributor has the option choosing between two types of distribution, e.g., one with, and one without a permutator.

One way to use the reconfiguration is as follows. During production the distributor is equipped with one or more types of permutation. During use, a table is stored, in the table, for each communication protocol, the optimal permutation type is kept. The table may be precomputed once, and stored on the device during manufacturing, or stored later, for example, downloaded from a server. The device may also try different types of permutators for each protocol and store the permutation that worked best.

A practical embodiment of the data handling system according to the invention is characterized by the measure of claim 10.

If an access module is substantially full, the data handling system must temporarily be prevented from taking in more input, as those cannot be handled. To achieve this, the distributor may comprise a stalling module to collect the stalling information from the plurality of access modules and to forward this information to those systems that may supply the data handling system with more commands.

This feature has the advantage that data loss, unpredictable behavior, or worse a crash of the data handling system is prevented.

Substantially full must be considered in conjunction with the mode of operation of the access modules and the data handling system, combined with the operation of a containing system in which the data handling system is comprised. The access modules must give a signal in time for the distributor and/or other modules in the containing system to act upon the signal. For example, if the operation of the data handling system and/or the containing system is pipe-lined, some commands may be in the pipe line at the moment a stalling signal is given. The commands already in the pipe line may not be conveniently delayable; therefore allowance must be made for those objects by giving the stalling signal in time. For example, when it may be that one command cannot be delayed, for example, if the distributor is pipe-lined, the access module must give a stalling signal when only capacity for one more command is left.

A practical embodiment of the data handling system according to the invention is characterized by the measure of claim 11.

To select a specific distributor output for a specific command, received by the distributor, it may be necessary to perform arithmetical operations in relation to the number of memory banks. Such operations are easier to perform if the number is a power of two. For example, to select a memory bank and corresponding access module based on an index, the index may be computed modulo the number of memory banks. Also, an address function may comprise the step of computing or dividing an index by the number of banks.

A computation modulo a power of 2 or a division by a power of 2 can be performed by shifts and bit mask operation, as is well known to a person skilled in the art.

The method for rearranging data according to the invention is characterized by claim 12.

Other processing steps may be done before, after or in between the steps. Moreover, a part of the reading and writing operations can be interleaved, i.e. a first number of write commands can be performed, then a second number of read commands, then a third number of write commands and then a fourth number of read commands, etc.

The method for rearranging data is particularly advantageous for data interleaving.

The method for rearranging data is also particularly advantageous for a multiplexer.

In case the method for rearranging data is used as a multiplexer, the first set of write commands corresponds to two or more input data streams. In that case, the set of read commands corresponds to a single output data stream.

The set of write command is used as part of the first plurality of commands. The set of read commands is used as part of the first plurality of commands.

The rate matcher according to the invention is characterized by claim 13.

For some applications, e.g., for most communication protocols, it is necessary that all data is portioned in blocks of a predetermined size. If the natural size of the data blocks is smaller or larger than the predetermined size, such blocks need to be made smaller or larger. A person skilled in the art knows that there are several rate matching schemes available. Using the invention, a convenient way to arrange this is to instruct the rearrangement network to delete, insert or repeat some data. As the data is available when the data comes through the rearrangement network it is a computationally small matter to achieve this. However, in a situation where the rate matching is performed at a different point, the data would need to brought together again, incurring more computational cost.

It is to be noticed that U.S. Pat. No. 5,938,763 provides a system for interleaving data using an architecture built on the principle of memory reuse by means of the reuse of read addresses, i.e., every read access is followed by a write access to the same memory address. The invention imposes no such restrictions on the access sequences, but instead maximizes the effective use of memory cycles.

### BRIEF DESCRIPTION OF THE DRAWINGS

The invention is explained in further detail, by way of example and with reference to the accompanying drawings, wherein:

FIG. 1 is a block diagram illustrating a first embodiment of the data handling system according to the invention.

FIG. 2 is a block diagram illustrating a first embodiment of the rearrangement network.

FIG. 3 is a block diagram illustrating a second embodiment of the rearrangement network

FIG. 4 is a block diagram illustrating a buffer comprised in the rearrangement buffer

FIG. 5 is a block diagram illustrating an element selection network.

FIG. 6 is a block diagram illustrating a first embodiment of the distributor.

FIG. 7 is a block diagram illustrating a second embodiment of the distributor.

FIG. 8 is a block diagram illustrating a stalling module comprised in a distributor.

FIG. 9 is a block diagram illustrating a data handling system.

FIG. 10 illustrates an embodiment of access module.

Throughout the Figures, similar or corresponding features are indicated by same reference numerals.

### LIST OF REFERENCE NUMERALS

100 a data handling system
101 an input
102 a distributor
103 an output
104 a plurality of access modules
106 a plurality of memory banks
108 a rearrangement network
110 an access module
112 a memory bank
200 a rearrangement buffer
202 an element selection network
300 a data object buffer
302 a tag selector
304 a connection
400 a buffer cell
402 a forward line
500 a MUX
600 a permutator
700 a reconfiguration module
702 a receiving of a reconfiguration data
800 a stalling module
1000 an access buffer cell
1002-1010 a connection from a distributor to an access module
1012 an access buffer cell connection

### DETAILED EMBODIMENTS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described.

For convenience, the data handling system is described for the general embodiment, in which a distributor receives a sequence of command vectors and a rearrangement network produces a sequence of data object vectors. The invention is however applicable to any stream of commands and can produce any required stream of data objects.

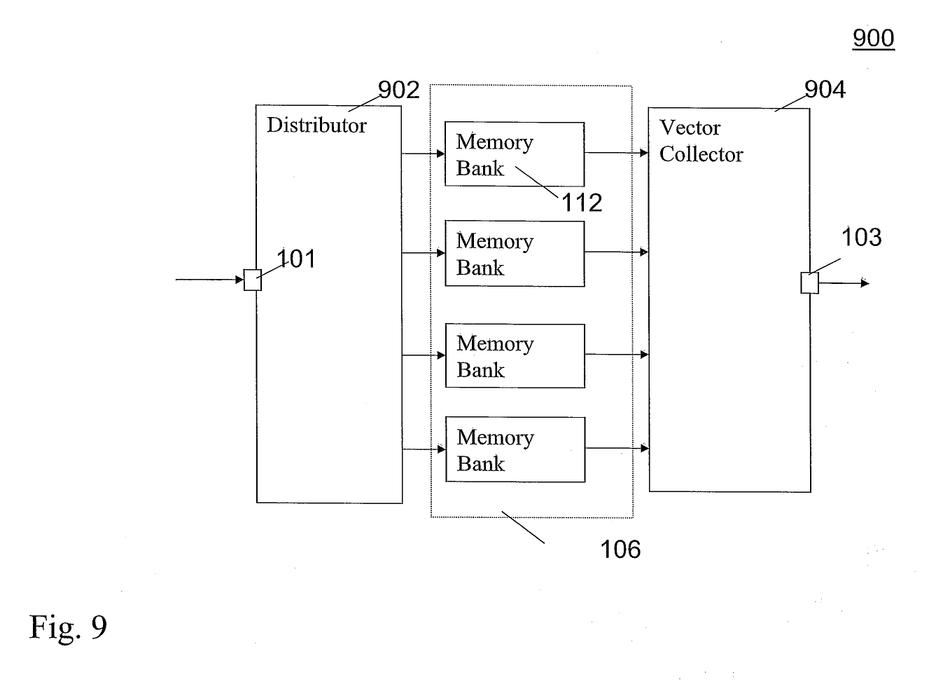

An approach to satisfy the ever increasing throughput demands of interleaving architectures is depicted in FIG. 9. In FIG. 9 a multi-bank architecture for the memory is shown. The multi-bank architecture comprises a distributor (902) for distributing an incoming sequence of read or write commands occurring at an input (101) over a plurality of memory banks (106). Each of the plurality of memory banks is connected to a vector collector (904). The incoming sequence is divided into command vectors. In the case of a read command vector the data for the vector outputted by the memory banks needs to be collected and outputted. This is done by the “vector collector”.

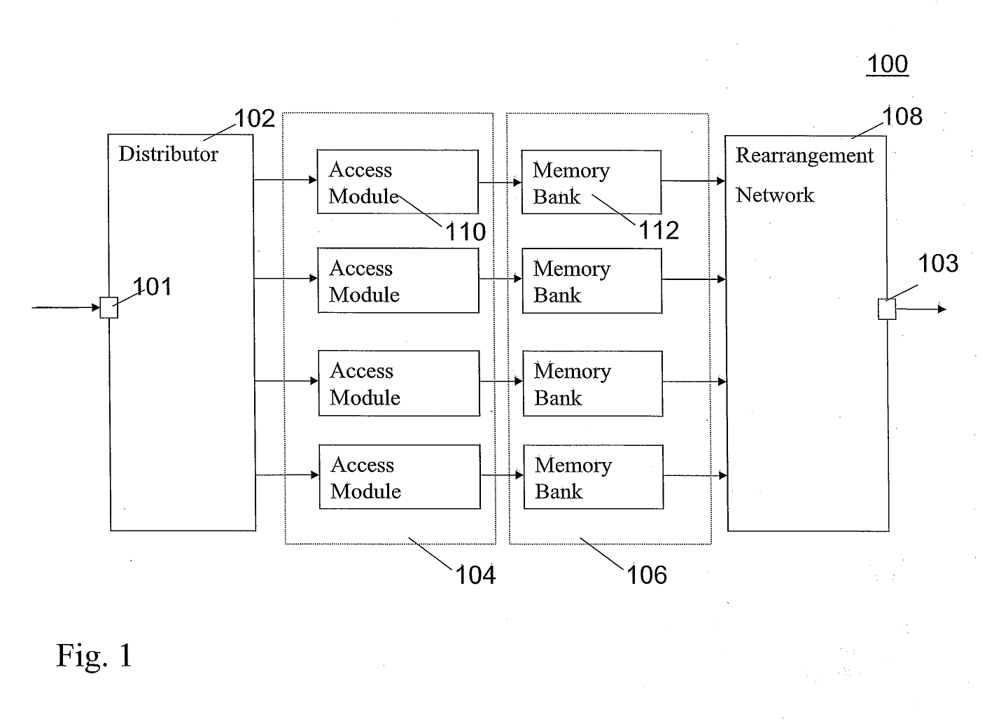

In FIG. 1 a block diagram is shown, illustrating a first embodiment of the data handling system (100). The distributor (102) receives at an input (101) a first sequence of command vectors. The first sequence of command vectors comprises read command vectors and write command vectors. Each command vector comprises a set of commands in a ranking A typical read command comprises an index, such as an address. A typical write command comprises an index and a data object.

The distributor (102) distributes the commands among a plurality of distributor outputs. The plurality of distributor outputs is connected to a plurality of access modules (104); the connection is done in such a way that each distributor output corresponds to one respective access module. Access module (110) is typical for all the access modules. Each access module comprises a buffer that is capable of buffering the commands that occur at the distributor output that corresponds to that access module. An access module is capable of buffering read commands and write commands. Note, that it is not essential that the distributor forwards, the literal command that the distributor received, to an access module. Some processing may be done on the command before or during the distributing.

The plurality of access modules (104) is connected to a plurality of memory banks (106); the connection is done in such a way that each access module corresponds to one respective memory bank. Memory bank (112) is typical for all the memory banks. Each memory bank is capable of retrieving data objects in response to an index or address. Each memory bank is capable of storing a data object.

The plurality of memory banks (106) is connected to a rearrangement network (108). The rearrangement network (108) receives from the plurality of memory banks (106) data objects. Each data object that the rearrangement network (108) receives from a memory bank out of the plurality of memory banks (106) was retrieved in response to a read command.

The rearrangement network (108) rearranges the data objects that the rearrangement network (108) received from the memory banks (106) and produces a second plurality of data objects at an output (103). The order of the data objects can be changed. If two or more data objects must be issued from the rearrangement network (108) as a set in parallel, for example, because the corresponding read commands were also received as a set in parallel, the rearrangement network (108) can change the order within the set of data objects, as well as the relative placement of the set within the outputs of the rearrangement network (108).

The distributor (102) comprises one distributor output that is connected to access module (110). Access module (110) is connected to memory bank (112). Memory bank (112) stores a data object in response to a write command. Memory bank (112) retrieves a retrieved data object in response to a read command. The retrieved data object is sent from memory bank (112) to the rearrangement network (108). The rearrangement network (108) can place the retrieved data object at the output (103) at any point. Rearrangement network (108) can be configured to omit the retrieved data object, for example, if the rearrangement network (108) is configured as a rate matcher. The rearrangement network (108) can place the retrieved data object at the output (103) also multiple points, by repeating or reusing the same data object. Using an object at multiple points may be achieved by omitting to remove the object from a rearrangement buffer (200).

An access module comprises a First In, First Out queue (FIFO queue). The plurality of access modules (104) decouples the processing of accesses, i.e. commands, for the different banks, by rescheduling the accesses in time. Accesses can now be executed “out of order”. This means that banks need no longer stall each other when faced with a collision. Higher memory efficiency can thus be attained. Out of order reading only becomes possible when combined with a rearrangement network (108), since data objects can come in response to multiple read command vectors.

During operation the distributor (102) receives a sequence of command vectors. The distributor (102) distributes the contents of the command vectors among the plurality of access modules (104). The distributor (102) distributes a read command to that distributor output that is connected, via an access module, to a memory bank that contains the requested data object. Typically the read command comprises an index that is indicative of the physical location where the data is to be retrieved. The distributor (102) selects the distributor output connected to the memory bank that comprises the physical location indicated by the index.

The distributor (102) distributes a write command to that distributor output that is connected, via an access module, to a memory bank that should contain the data object that was supplied with the write command. Typically the write command comprises an index that is indicative of the physical location where the data is to be stored. The distributor (102) selects the distributor output connected to the memory bank that comprises the physical location indicated by the index.

Typically the distributor (102) works in cycles. At each cycle one command vector is distributed among the distributor outputs. If a command needs access to a particular memory bank, the command is sent to the particular access module that is connected to that memory bank; the particular access module temporarily buffers the command until the memory bank can process the command. If two or more commands need access to the same memory bank, the two or more commands are all sent to the same access module. The access module buffers the commands in the order they were received and forwards the commands to his memory bank, one at a time, when the memory bank can process the command. Typically the memory bank works in cycles, and can process one command at each cycle.

In this embodiment, the rearrangement network (108) assembles a sequence of data object vectors. Such that each data object vector was retrieved in response to one corresponding read command vector. Each data object in a data object vector has a particular ranking and was retrieved in response to a read command of the same ranking in the corresponding read command vector. Moreover, the order of the read command vectors is equal to the order of the read command vectors that correspond one-to-one to data object vectors.

The distributor (102) sends information to the rearrangement network (108) on how the sequence of data object vectors are to be arranged. The distributor (102) can send information to the rearrangement network (108) in a number of ways. First the distributor (102) can attach to each read command a tag that represents the information; as the read command progresses through the system the tags progress along. When a data object is retrieved in response to a read command the tag attached to the read command is attached to the data object. In this way, the tags arrive in the rearrangement network (108). To accommodate the tags the buffers comprised in access modules or in the rearrangement network (108) need to be suitably sized.

In this embodiment the distributor (102) attaches to each read command a tag selected in sequence from a tag sequence. The tag sequence consists of all integers that can be written with a predetermined fixed number of bits. For example, the sequences could be the sequence 0, 1, 2, . . . , 2̂16−1=65535. Other tag sequences are possible and possibly advantageous. In this embodiment no second communicative connection is used.

Embodiments of the rearrangement network (108) are described below.

The data handling system (100) can be made using dedicated hardware, such as electronic circuits that are configured according to this invention. The data handling system (100) (106) can be made from generic hardware controlled using software, or the data handling system (100) may comprise a combination of dedicated hardware, generic hardware and software to implement the data handling system (100).

The buffers and memories used, such as memory bank (112) or access module (110) or comprised in the distributor (102) or comprised in the rearrangement network (108) can be made from regular RAM memory, such a DRAM, SRAM or SDRAM, flash memory, magnetic storage, such as a hard disk, or optical storage, or any other kind of suitable storage. Optionally a memory bank (112) could use ROM memory as well. In case ROM is used, the data handling system (100) can only be used for the retrieval of data objects, not for storage.

The connections, between the distributor (102) and the plurality of access modules (104), and between the plurality of access modules (104) and the plurality of memory banks (106), and between the plurality of memory banks (106) and the rearrangement network (108) can be fabricated in a number of ways, for example, a connection can be done parallel, or using a bus architecture.

The distributor (102) is used advantageously in a vector architecture wherein the distributor (102) receives a sequence of command vectors. However, the distributor (102) can also be used if the sequence is a linear sequence of commands. In that case the distributor (102) accepts a number of these commands and regards the set as a vector. Similarly the rearrangement network (108) can output a data object vector in a linear fashion, if so desired.

The data handling system (100) according to the invention has numerous advantages. Since the data handling system (100) uses a plurality of access modules (104) the data handling system (100) can handle, a plurality of commands that contains one or more memory bank conflicts, gracefully. In case of a conflict there is no need to stall the data handling system (100) or take other corrective action. Each conflict is buffered in an access module and handled by the memory bank in turn.

Since the data handling system (100) uses a rearrangement network (108) the plurality of data objects can occur at the output (103) in any desired ordering. This has the advantage that the rearrangement network (108) can perform operations on the data as the data is coming through. In particular, the rearrangement network (108) can rearrange, repeat, delete or insert data.

If the rearrangement network (108) outputs the data objects in the same order as the read commands were received, this has additional advantages. The data handling system (100) has a much higher throughput and capacity than a conventional data handling system based on a single memory bank. The data handling system (100) suffers from conflicts less frequently than a conventional multi-bank data handling system. At the same time this is transparent to a user of the data handling system (100).

In one embodiment, the data handling system (100) is used in an asynchronous design. The commands do not arrive synchronized to a clock, but when some other component needs to read or write a data object. As a result the commands can come one by one, or some at a time.

Below the effect of access queues is illustrated with a worked example. It is assumed that the distributor (102) distributes a sequence of read command vectors over 5 memory banks. In this example the data handling system (100) is used by the interleaving function I. The interleaving function I, in terms of input indices, which are to be mapped to the 5 memory banks, is, for example:

I: {{0,6,16,2,12},{3,13,4,14,5},{7,8,9,19,10}, {15,17,11,18,1}}.

The corresponding bank numbers are (I (i) mod 5):

{{0,1,1,2,2},{3,3,4,4,0},{2,3,4,4,0},{0,2,1,3,1}}

First, the situation is considered in a system, which does not use access modules. Counting the frequencies of bank occurrence in access vectors for all 5 vectors gives the following table, the interleaving pattern is used twice.

| | Bank | | | | |
|---|---|---|---|---|---|
| | 0 | 1 | 2 | 3 | 4 |
| Access vector 0 | 1 | 2 | 2 | 0 | 0 |
| Access vector 1 | 1 | 0 | 0 | 2 | 2 |
| Access vector 2 | 1 | 0 | 1 | 1 | 2 |
| Access vector 3 | 1 | 2 | 1 | 1 | 0 |

Number of bank accesses per access vector

This table is indicative for the memory efficiency. Without the use of access queues, a total of 16 cycles is required for two blocks of the interleaving function I. Without conflicts, in 16 cycles one would get 16*5=80 data objects. However, in the above example, only 4*5*2=40 data objects were retrieved. This corresponds to a memory efficiency of only 50%.

The scenario with a data handling system (100) according to the invention, that uses access modules, is much better. The table below displays the number of commands, i.e. accesses, buffered in each access module for every cycle. Also here the interleaving pattern is used twice.

| | Bank | | | | |
|---|---|---|---|---|---|
| Access module | 0 | 1 | 2 | 3 | 4 |
| Cycle 0 (Access vector 0) | 1 | 2 | 2 | 0 | 0 |
| Cycle 1 (Access vector 1) | 1 | 1 | 1 | 2 | 2 |
| Cycle 2 (Access vector 2) | 1 | 0 | 1 | 2 | 3 |
| Cycle 3 (Access vector 3) | 1 | 2 | 1 | 2 | 2 |
| Cycle 4 (Access vector 0) | 1 | 3 | 2 | 1 | 1 |
| Cycle 5 (Access vector 1) | 1 | 2 | 1 | 2 | 2 |
| Cycle 6 (Access vector 2) | 1 | 1 | 1 | 2 | 3 |
| Cycle 7 (Access vector 3) | 1 | 2 | 1 | 2 | 2 |
| Cycle 8 (draining) | 0 | 1 | 0 | 1 | 1 |
| Cycle 9 (finished) | 0 | 0 | 0 | 0 | 0 |

Number of elements in access queues per cycle

This yields an efficiency of (1−(5/45))×100%=89%, with a maximum queue size of 3.

Although the access modules, comprising access queues, and rearrangement network (108) may introduce additional latency to the interleaving operation, this will be acceptable for most interleaving schemes. Especially, if the interleaving schemes is used in a latency tolerant application.

In one embodiment of the distributor (102) each distributor output has a corresponding access module number. Each specific read command comprises a specific index. The distributor (102) computes a specific computed access module number by computing the index modulo the number of memory banks in the plurality of memory banks (106). The distributor (102) distributes the specific read command to the distributor output corresponding to the specific computed access module number.

In a further refinement of this embodiment of the distributor (102), the number of memory banks is a power of 2. The computing modulo the number of memory banks, is implemented as a bitwise ‘AND’ operation with a bit mask.

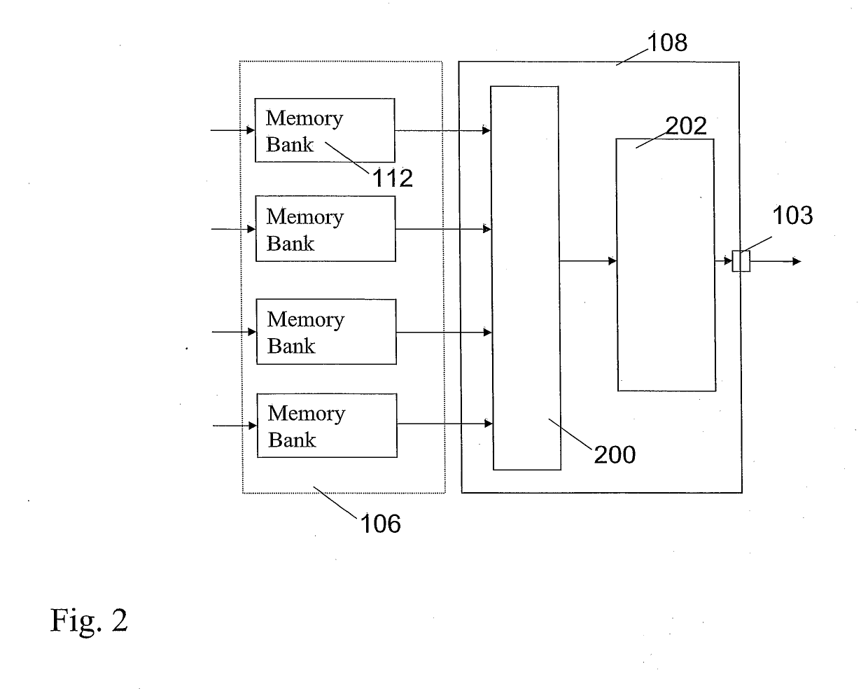

FIG. 2 illustrates a first embodiment of the rearrangement network (108). In this embodiment the rearrangement network (108) comprises a rearrangement buffer (200) and an element selection network (202).

The plurality of memory banks (106) supplies data objects in response to read commands to the rearrangement buffer (200). The element selection network (202) selects elements from the rearrangement buffer (200) that are to be outputted.

An output of memory bank (112) is connected to the rearrangement buffer (200), which is connected to the element selection network (202) which is connected to the output (103).

Preferably the element selection network (202) selects the elements of a data object vector.

In a preferred implementation the rearrangement buffer (200) also buffers a tag, which the rearrangement buffer (200) received together with a data object. Preferably the element selection network (202) selects elements from the rearrangement network (108) based on the tag. After a data objects has been selected by the element selection network (202) from the rearrangement buffer (200), the data object occurs at the output (103) and the data object and associated tag is discarded from the rearrangement buffer (200).

The rearrangement buffer (200) can be made from memories similar to those suitable for the access modules (104) or in the memory banks (106).

The advantage of a rearrangement buffer (200) and element selection network (202) is that the data objects can be temporarily stored in the rearrangement buffer (200) before they need to be selected. An additional advantage is that the architecture is split in a logic part and a memory part, as a result conventional memory storage techniques can be reused to create a functional rearrangement network (108).

A second embodiment of a rearrangement network (108) is the following. The rearrangement network (108) comprises a vector construction memory and a vector filling network. The vector construction memory comprises a number of vectors slots. Each vector slot comprises data objects or dummy values. The plurality of memory banks (106) supplies data objects to the vector filling network. The vector filling network determines for each data object that the vector filling network receives, in which vector slot the data object is to be placed. A placed data object replaces a dummy value. When a vector slot does not comprise a dummy value the vector slot is outputted at output (103) in the form of a data object vector. After a vector slot is outputted, the data objects in the outputted vector slot are replaced with dummy values. Preferably, if two or more vector slots do not comprise dummy values, a tie breaking means determines the order in which the vector slots are outputted. For example, an order determination can be made on the basis of tags, or on the basis of time stamps, or on the order in which the vector slots are stored in memory. Alternatively, the rearrangement network (108) according to this embodiment, can delay the outputting of a vector slot, to allow another vector slot to complete and to be outputted. Preferably, the vector slots initially contain only dummy values.

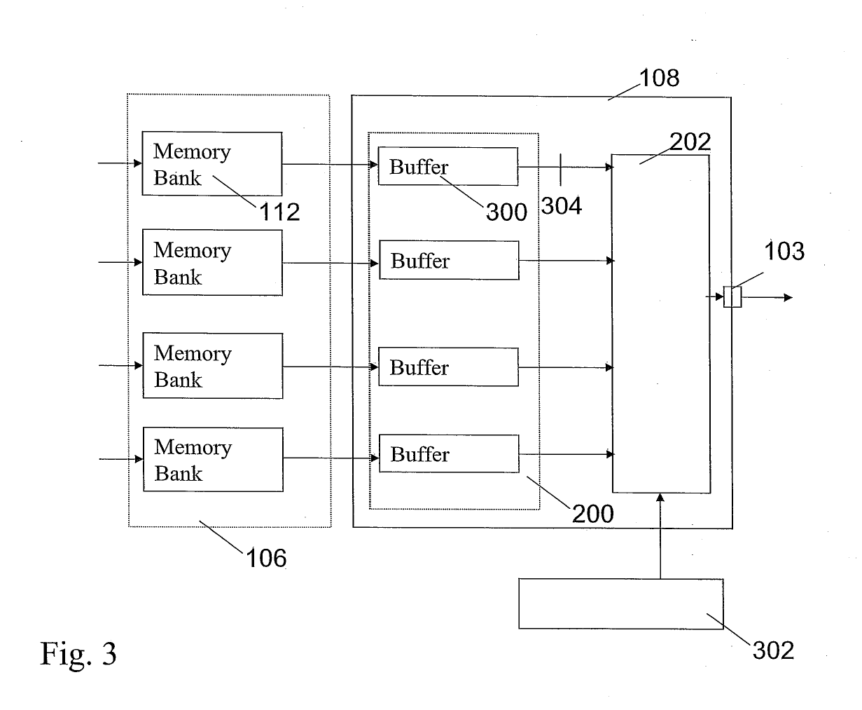

FIG. 3 illustrates a third embodiment of the rearrangement network (108), which is a refinement of the rearrangement network (108) of FIG. 2. The rearrangement buffer (200) comprises a plurality of buffers. Each specific memory bank supplies data objects to a specific buffer in the plurality of buffers. One of the buffers in the plurality of buffers comprised in the rearrangement buffer (200) is data object buffer (300). Buffer (300) is typical for all the buffers in the plurality of buffers comprised in the rearrangement buffer (200). Buffer (300) is connected with an element connection network (202) via a connection (304).

Memory bank (112) is connected to buffer (300). The plurality of buffers (200) is connected to the element selection network (202). The element selection network (202) is connected to a tag selector (302). The tag selector (302) instructs the element selection network (202) which tag(s) need to be selected for outputting.

In a preferred embodiment, the tag selector (302) sends a sequence of tag vectors. Each tag vector comprises a set of tags in a ranking. A specific tag of a specific rank instructs the element selections network (202) to select a specific data objects with a tag substantially equal to the specific tag. The specific data object is selected for output in a data object vector; the specific data object has the specific rank in the data object vector.

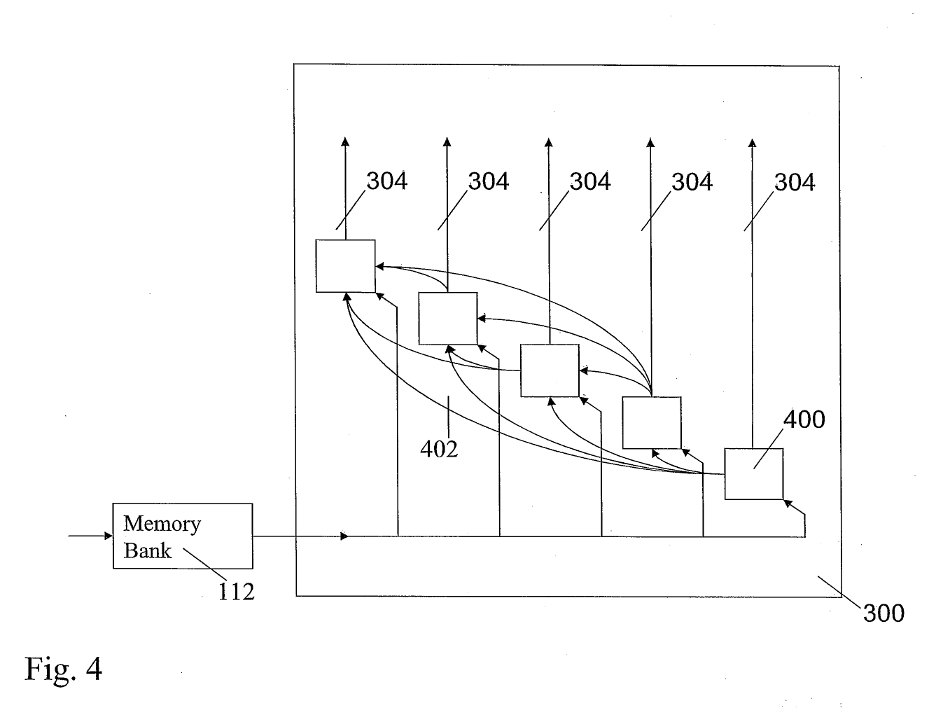

FIG. 4 illustrates an embodiment of buffer (300). The embodiment is shown for a data handling system (100) outputting data object vectors, each comprising 8 data objects. The access modules in this embodiment have a capacity to buffer 5 read commands. Note that these dimensions are for illustrative purposes only.

Memory bank (112) supplies data objects to the input line of buffer (300). Buffer (300) comprises a plurality of buffer cells. Each buffer cell can buffer one data object and one associated tag. In this embodiment there are 5 buffer cells. One buffer cell (400) is typical for all the buffer cells in buffer (300). The buffer cells are ordered in a hierarchy. Each buffer cell is connected, with forward lines, to all the buffer cells that are higher in the hierarchy. For example, buffer cell (400) is the lowest in the hierarchy and is connected via forward line (402) to the buffer cell that is highest in the hierarchy. Note that, in FIG. 3, the connection (304) between buffer (300) and the element selection network (202) is depicted with a single line, but in FIG. 4, the same connection (304) is depicted with 5 lines.

A data object received from memory bank (112), is stored in the first free buffer cell that is highest in the hierarchy. The element selection network (202) uses connection (304) to select a data object from a buffer cell. After a buffer cell was selected the contents of the buffer cell is cleared. Using the forward lines the data objects stored in a buffer cell of lower hierarchy than the selected buffer cell are moved up to a buffer cell that is one higher in the hierarchy.

A control signal from the element selection network (202) to a buffer indicates which outputs were selected. The buffer applies the appropriate shifts and enables the correct buffer cell for the next input.

An advantage of this architecture is that, the tags stored in the buffer cells, are always in descending order, according to the tag sequence. This makes for faster access when searching for a particular tag. That is, a first buffer cell that is higher in the hierarchy than a second filled buffer cell has a lower tag according to the tag sequence.

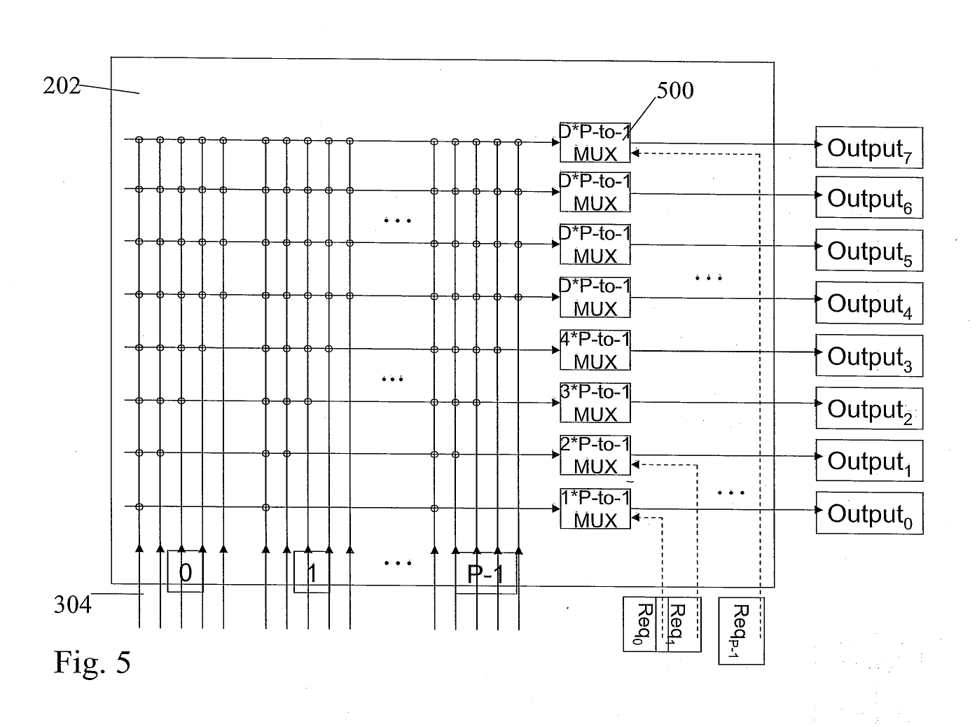

FIG. 5 illustrates a first embodiment of the element selection network (202). The embodiment is shown for a data handling system (100) outputting data object vectors, each comprising ‘P’=8 data objects. The access modules in this embodiment have a capacity to buffer ‘D’=5 read commands. This embodiment also has P memory banks. Note that these dimensions are for illustrative purposes only.

The element selection network (202) comprises P multiplexers (MUXs). A MUX is a device that performs multiplexing. The MUX compares a plurality of tags, comprised in the rearrangement buffer (200), with one requested tag, received from a tag selector (302). If a matching tag is found, then the data object that corresponds to the matching tag is outputted onto a single line.

In a practical embodiment (not shown) each MUX is connected to each buffer cell in the rearrangement buffer (200). In this case each MUX comprises D×P input lines, that is D connections like (304) coming from each one of the P memory banks.

In a preferred embodiment (shown in FIG. 5) the buffer cells in the buffer (300) are kept in descending order. As a result not all of the MUXs need to have the same number of input lines. Some of the input lines become redundant, as they cannot produce a match any more. For example, for the tag corresponding to the first element in an output vector can only come from the first element of a data object buffer. For example, for the tag corresponding to the second element in an output vector can only come from the first two elements of a data object buffer.

The MUX (500) is typical for the other MUXs. The MUX (500) is connected to connection (304). MUX (500) is also connected to at least part of the connections of the other buffers in the plurality of buffers in the rearrangement buffer (200). The MUX (500) receives a request from the tag selector (302). Out of all the buffers the MUX (500) selects the buffer cell that has substantially the same tag as the request. When the requested tag was found the associated data object is outputted.

Every MUX sends a feedback signal to the data buffers to inform them which element(s) has/have been read. The data buffers will then perform the correct shift, if applicable.

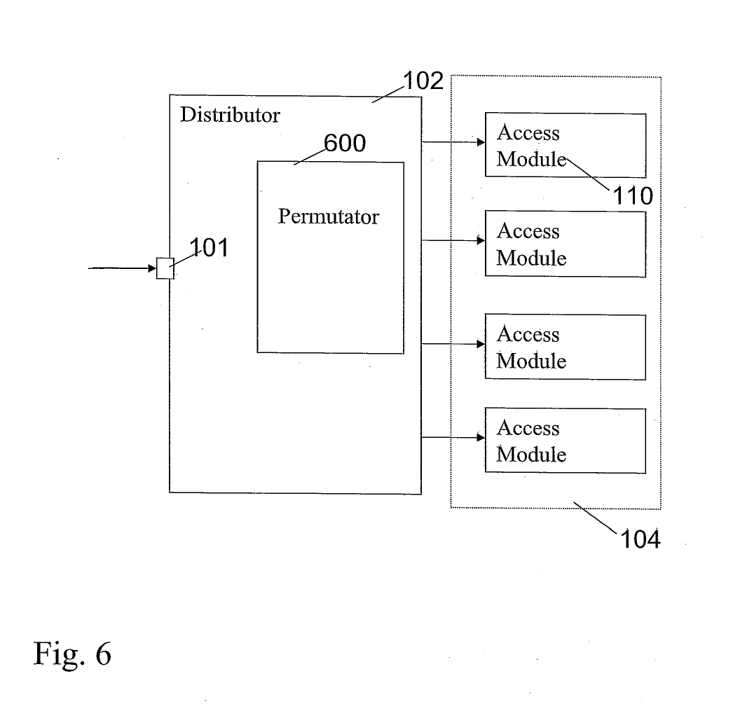

In FIG. 6 a block diagram illustrating a first embodiment of the distributor (102). The distributor (102) comprises a permutator (600).

After the distributor (102) receives a command comprising an index, the permutator (600) performs a processing of the received index. According to the result, the distributor (102) distributes, i.e. selects a distributor output for, the command.

If bank conflicts are not, at least to a certain extent, uniformly distributed over the plurality of memory banks (106) then the access modules will be full more often. A full access module may stall the system. One solution to this problem is large access modules. However, using a permutator (600) provides a better solution. With a permutator (600) small access modules can be used, yet still avoiding bank conflicts.

In a second embodiment the distributor (102) makes a provisional assignment to a distributor output for each received index. The permutator (600) can redistribute this provisional assignment. A good choice is to redistribute using a relative cyclic shift permutation. The number of right shifts is indicated by the write access vector number of the data element. The cyclic shift permutation is, for example, suitable for the standards: 802.11a/g, DVB, UMTS HSDPA and UMTS R99.

The write access vector number can be obtained by counting the write command vectors as they arrive at the distributor (102). The first write command vectors has write access vector number 1, the second write command vectors has write access vector number 2, and so on. Alternatively, when the pattern of access is known, for example if a known interleaving pattern is used, the write access vector number can be obtained by a processing of the index comprised in a command in the vector, for example the first command.

Alternatively, the permutator (600) can be integrated with the distributing.

The permutation, applied by the permutator (600), is used for a whole interleaving block. This permutation is to be performed on the write accesses and read accesses, thereby canceling its effect on the final element order. By performing this permutation, the local non-uniformity of bank conflicts is broken and the gained uniformity can be exploited for parallelism. Since the access sequences for interleaving are deterministic, a simulation can determine the particular permutation resulting in the best distribution of bank conflicts for every individual interleaving scheme.

In one embodiment of the permutator (600), each distributor output has a corresponding access module number. Each specific read command comprises a specific index. The permutator (600) is arranged to compute a specific access module number by processing the specific index in accordance with a bank function. The distributor (102) distributes the specific read command to a distributor output corresponding to the specific access module number. This embodiment of the permutator (600) could be combined with any embodiment of the invention that uses a permutator (600). The bank function could be computed as follows.

1. dividing the index by the number of memory banks, if necessary rounding the result down.
2. adding the result of the division to the index.
3. computing the result of the adding modulo the number of memory banks

When the number of memory banks is a power of two, the division can be implemented as a bitwise shift.

Note, that the result of a first number modulo a second number can computed as follows: the first number is divided by the second number, the result is rounded down, this is the integer quotient. Next the second number is multiplied by the integer quotient; the result of the multiplication is subtracted from the first number. The result is the integer remainder. The integer remainder is the result of the first number modulo the second number. The person skilled in the art is well versed in the art of arithmetic, including modulo operations.

This bank function can also be advantageously implemented in hardware, by first selecting a memory bank according to a number of bits of the index, for example a number of the most significant bits, and second shifting to a next memory bank a second number of times; wherein the second number is indicated by a second number of bits of the index, for example a number of the least significant bits of the index.

In general bank functions need not be executed by an arithmetical processor, although this is possible. It may be advantageously to lay down the bank functions in hardware circuits that perform an equivalent computation. The equivalent computation may only be visible in the fact that a distributor output is chosen based on the index.

The bank function can also be computed as

1. computing the result of the index modulo the number of memory banks.

This bank function is, e.g., advantageous for linear reads, e.g., an index sequence of 0, 1, 3, etc,

Those skilled in the art will appreciate that the bank functions described above can be implemented in any number of variations and in many suitable ways, e.g., in hardware, in software, or in a combination thereof, without departing from the present invention. For example, the order of certain operations carried out can often be varied, additional operations can be added or operations can be deleted without departing from the invention.

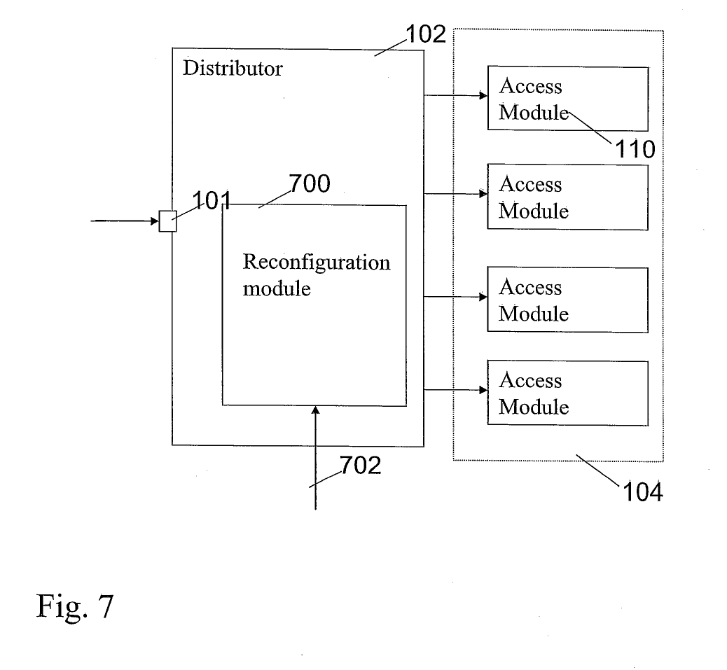

FIG. 7 illustrates a second embodiment of the distributor (102), wherein the distributor (102) comprises a reconfiguration module (700).

The reconfiguration module (700) can receive a reconfiguration data at an input (702).

In particular, the reconfiguration module (700) can reconfigure a permutator (600). The permutator (600) is reconfigurable. For example, the permutator allows a choice of a set of pre-defined permutations or no permutation at all.

Reconfiguration has the advantage that the best option can be applied for a particular application. For example, if the data handling system (100) is used for multiple communication standards, each with a different interleaving scheme, the data handling system (100) can be optimized for each communication standard.

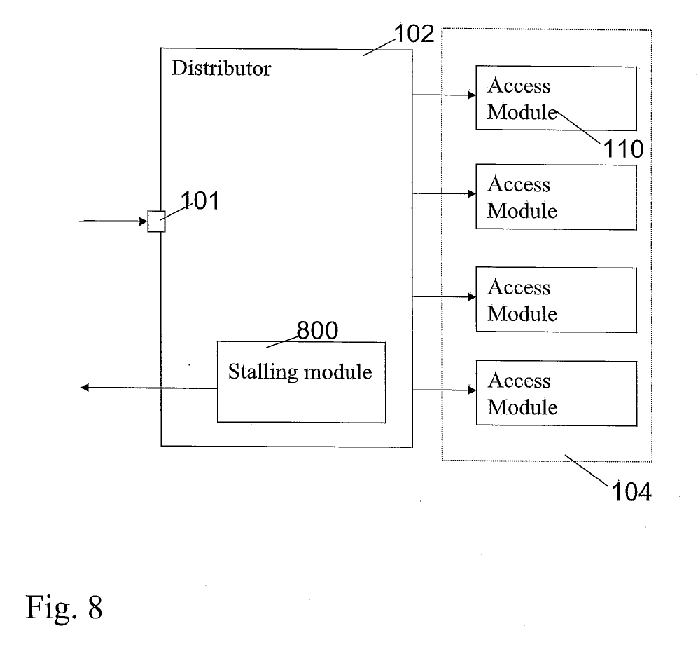

FIG. 8 illustrates how a stalling module (800) may fit in the data handling system (100). The distributor (102) comprises a stalling module (800). The stalling module (800) can deliver a signal external to the data handling system (100) indicating that the data handling system (100) is currently unable to accommodate new commands.

In the first embodiment of the stalling module (800), the stalling uses the following method. After an access module receives a command for buffering from the distributor (102), the access module sends a confirmation signal to the stalling module (800). The confirmation signal signals whether the received command fits in the access module or whether the command did not fit and was discarded. If the stalling module (800) does not receive a confirmation signal that signals that an access module was full and had to discard the command, the stalling module (800) allows the distributor (102) to proceed with the next command vector. However, if the stalling module (800) receives a confirmation signal indicating that an access module is full; the stalling module (800) will then send a signal to the plurality of access modules (104), that those access modules who buffered a command must discard the command. At this point the stalling module (800) signals externally that the data handling system (100) is currently unable to accommodate new commands. Hereafter, the distributor (102) retries sending the same set of commands.

In a second embodiment of the stalling module (800), all access modules signal at each time to the stalling module (800) whether they are substantially full or not. The stalling method can signal to the access modules if the last received command is valid or not. The stalling uses the following method. If an access module determines that the access module is substantially full, the access module signals to the stalling module (800) that the access module is substantially full. If the stalling module (800) receives a signal that at least one access module is substantially full, the stalling modules (800) marks the last command in each access module as invalid. At this point the stalling module (800) signals externally that the data handling system (100) is currently unable to accommodate new commands. If, hereafter, the stalling method (800) receives from no access modules a signal that the access module is substantially full, the stalling module (800) causes the distributor (102) to resend the command to the access module that discarded a command, and the stalling module (800) marks all commands as valid. The advantage is that no commands need to be discarded in the access modules.

If the stalling module (800) has the data handling system (100) stalled, the plurality of access modules (104), the memory banks (106) and the rearrangement network (108) continue the handling of already accepted commands. In this way, the access modules are emptied and new commands can be accepted again.

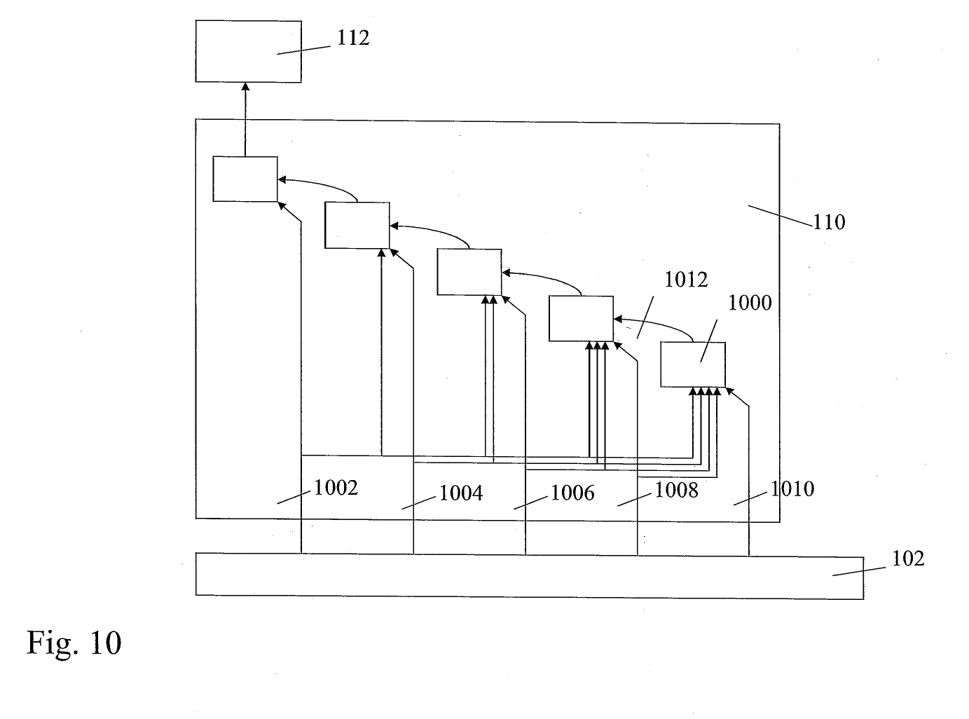

FIG. 10 illustrates an embodiment of access module (110). The embodiment is shown for an access module (110) with a capacity to buffer 5 commands. Note that these dimensions are for illustrative purposes only.

The five commands can be buffered in five access buffer cells (1000), all 5 are shown. The buffer cells are ordered in a hierarchy. The cell labeled (1000) is the lowest in the hierarchy, the cell directly connected to memory bank (112) is the highest in the hierarchy.

The connection between distributor (102) and access module (110) is done in the form of parallel connections to all the access buffer cells (1000). All connections from distributor (102) to access module (110), (1002), (1004), (1006), (1008), and (1010) are connections from the same distributor output to the same access module (110).

The first output (1002) is connected to all access buffer cells. The second output (1004) is connected to all access buffer cells, except the one of the highest hierarchy. The third output (1006) is connected to all access buffer cells, except the first two of the highest hierarchy. The last output (1010) is only connected to the access buffer cell (1000) of the lowest hierarchy.

Each specific access buffer cell, not of the highest in hierarchy, is connected to the access buffer cell immediately above the specific access buffer cell in hierarchy, via an access buffer cell connection. The access buffer cell (1000) is connected via access buffer cell connection (1012) to the next buffer cell in hierarchy. The buffer cell of highest hierarchy is connected to memory bank (112).

During operation, if the distributor (102) needs to buffer a command in access module (110), the distributor puts the command on the connection from the distributor to the access module (1002). It is then routed to all the access buffer cells. The access buffer cell that is highest in hierarchy and is free will accept the command.

If the distributor (102) needs to buffer two commands in access module (110), which may happen because of a conflict with in a command vector, the distributor puts the first command on the connection from the distributor to the access module (1002). The second command is put on the connection from the distributor to the access module (1004). The first command is then routed to all the access buffer cells. The access buffer cell that is highest in hierarchy and is free will accept the first command. The second command is then routed to all the access buffer cells except the first one. The access buffer cell that is highest in hierarchy and is still free will accept the second command.

In this fashion, the distributor (102) can place up to 5 commands simultaneously in the access module (110). The contents of the access buffers cells are always places in the first available free access buffer cell of highest hierarchy.

When the access module (110) must deliver to the memory bank (112), the access module (110) forwards the contents, or a suitable representation, of the access buffers cell of the highest hierarchy, that is directly connected to memory bank (112), to memory bank (112). All the other cells now move their contents one place up in the hierarchy, via an access buffer cell connection.

A control signal from distributor (102) indicates how many inputs are communicated. Then the access module (110) applies the appropriate shifts and enables the corresponding connections from the distributor to the access module.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

1. A data handling system, wherein:
the system is configured for receiving at an input a first plurality of commands, the plurality of commands comprising a plurality of read commands, and for producing at an output a second plurality of data objects; the system comprising:
a plurality of memory banks;
a distributor connected to the input and having a plurality of distributor outputs, and which is configured to selectively distribute the plurality of read commands among the distributor outputs;
a plurality of access modules, each having a specific module input connected to a specific one of the distributor outputs and a specific module output connected to a specific one of the memory banks, and configured for buffering the particular read commands occurring at the specific distributor output; and
a rearranging network connected to bank outputs of the memory banks;
each respective one of the memory banks is configured for supplying to the rearranging network a particular data object in response to receiving a particular read command; wherein:
the rearranging network is connected to the output; and
the rearranging network is configured to rearrange the data objects received from the plurality of memory banks to produce the second plurality of data objects.

2. A data handling system as in claim 1, wherein:
the first plurality of commands is organized as a first sequence of command vectors,
each particular one of the command vectors comprises a particular first ordered set of multiple particular commands according to a ranking;
the plurality of read commands is organized as a first subsequence of read command vectors of the first sequence;
the second plurality of data objects is organized as a second sequence of data object vectors;
each particular one of the data object vectors comprises a particular second ordered set of multiple particular data objects according to the ranking;
wherein the system, in response to processing a next one of the read command vectors in the first subsequence the system produces a next one of the data object vectors in the second sequence, wherein a specific one of the data objects of a specific rank in the next data object vector is retrieved from a specific one of the memory banks in response to a specific one of the read commands of the specific rank in the next read command vector.

3. A data handling system as in claim 1, wherein the rearranging network
comprises a rearrangement buffer configured for buffering the data objects supplied by the plurality of memory banks,
wherein the rearranging network is configured to rearrange by selecting data objects from the rearrangement buffer.

4. A data handling system as in claim 1, wherein
the distributor assigns to each particular read command a particular tag, and
each memory bank assigns, in response to a specific read command with a specific tag, the specific tag to the specific retrieved data object,
wherein the rearrangement network is configured to select data objects according to the tags assigned thereto.

5. A data handling system as in claim 4 wherein the distributor assigns tags according to a tag sequence, and the rearrangement network selects data objects according to said tag sequence.

6. A data handling system as in claim 1 wherein:
the first sequence comprises at least one write command;
the distributor is configured to selectively distribute the write command among the distributor outputs;
a number of specific access modules of the plurality of access modules being configured for buffering the specific write command occurring at the specific distributor output; and
each respective one of the memory banks is configured for storing a particular data object in response to receiving a particular write command received from a respective access module,

7. A data handling system as in claim 1, wherein
the distributor comprises a permutator;
each specific command comprises a specific index;
the permutator is arranged to designate for each specific command a specific distributor output corresponding to a processing of the specific index; and
the distributor distributes the specific command to the specific designated distributor output.

8. A data handling system as in claim 7, wherein
the permutator is further arranged to compute a specific address by processing the specific index in accordance with an address function;
each memory bank is arranged to store or retrieve a specific data object in accordance with the specific address, and wherein
the processing of the specific index comprises adding the specific address to substantially the specific index.

9. A data handling system as in claim 1 wherein
the distributor comprises a reconfiguration module;
the reconfiguration module is arranged to receive a reconfiguration data;
the reconfiguration module is arranged to reconfigure the selectivity of the distributor in accordance with the reconfiguration data.

10. A data handling system as in claim 1 wherein
the distributor further comprises a stalling module, and wherein
at least one distinct access module is arranged to signal the stalling module if the distinct access module is substantially full, and wherein
the stalling module is arranged to temporarily prevent the distributor from distributing.

11. A data handling system as in claim 1 wherein the number of memory banks in the plurality of memory banks is a power of 2.

12. A method for rearranging data for use in a data handling system as in claim 1, comprising:
writing a set of data objects according to a first set of write commands, and
reading the set of data objects according to a second set of read commands.

13. A rate matcher comprising a data handling system as in claim 1 wherein
the rearrangement network comprises a rate matching module,
the rate matching module is arranged to receive a rate matching information,
the rate matching module is arranged to instruct the rearrangement network to:
repeat a data object; or
omit a data object; or
insert a data object.
